(19) United States
(12) Patent Application Publication
(10) Pub. No.: US 2013/0342356 A1
(43) Pub. Date: Dec. 26, 2013

(54) APPARATUSES, SYSTEMS, AND METHODS FOR SIGNAL COMMUNICATION ACROSS AN ELECTROMAGNETIC SHIELD

(71) Applicant: National Institute of Aerospace, Hampton, VA (US)

(72) Inventors: Chuantong Wang, Yorktown, VA (US); Stanley E. Woodard, Hampton, VA (US)

(73) Assignee: United States of America as represented by the Administrator of the National Aeronautics and Spac, Washington, DC (US)

(21) Appl. No.: 13/923,307

(22) Filed: Jun. 20, 2013

Related U.S. Application Data
(60) Provisional application No. 61/662,982, filed on Jun. 22, 2012.

(51) Int. Cl. G08C 19/00; G10K 11/24

(52) U.S. Cl. CPC G08C 19/00; G10K 11/24
USPC 340/870.01; 367/140

(57) ABSTRACT

One feature pertains to an apparatus for communicating signals across an electromagnetic (EM) shield. The apparatus includes a first communication interface positioned at a first side of the EM shield that receives a first signal containing data, where the first signal is incapable of being transmitted across the EM shield. The apparatus also includes a processing circuit positioned at the EM shield's first side that generates a control signal based on the first signal. The apparatus further includes a transducer positioned at the EM shield's first side that receives the control signal, generates a second signal containing the data based on the control signal, and transmits the second signal across the EM shield to a second side of the EM shield. The apparatus may further include a second signal receiver positioned at the second side of the EM shield that receives the transmitted second signal from the first transducer.

### CROSS-REFERENCE TO RELATED APPLICATIONS

The present application for patent claims priority to provisional application No. 61/662,982 entitled “Transparent and Ubiquitous Sensing Technology” filed Jun. 22, 2012, the entire disclosure of which is hereby expressly incorporated by reference.

### STATEMENT REGARDING FEDERALLY SPONSORED RESEARCH

This invention was made with Government support under contract NCC1-02043 awarded by NASA. The Government has certain rights in the invention.

### BACKGROUND

1. Field

Various features pertain to signal transmission, and in particular to methods and devices for signal transmission through a conductive shield.

2. Description of Related Art

In certain wireless communication systems, wireless communication devices communicate with one another directly through one or more types of electromagnetic waves/radiation. For example, two wireless communication devices, such as wireless sensors, may communicate with one another through radio waves, including short range and long range radio waves. As another example, two wireless communication devices may communicate with one another through microwaves, visible light, etc. Such communication may be possible so long as the wireless communication signals transmitted and received by the devices are not blocked or heavily attenuated by obstacles or barriers. For example, some wireless communication applications may require a line of sight between the wireless devices.

FIG. 1 illustrates a schematic block diagram of a wireless communication system 100 found in the prior art. The system includes a first wireless sensor 102 and a second wireless sensor 104. In the example illustrated, the sensors 102, 104 are capable of communicating with each other via radio waves or visible light. For example, the first sensor 102 may perform a sensing operation (e.g., sense temperature, pressure, humidity, wind speed, ionizing radiation, etc.) to obtain data and attempt to then transmit 105 the data to the second sensor 104. However, in situations where the first sensor 102 is electromagnetically shielded from the second sensor 104 the first sensor 102 cannot properly transmit the data to the second sensor 104.

In the example shown, the first sensor 102 is electromagnetically shielded from the second sensor 104 because the first sensor 102 is located within a conductive (e.g., metal) enclosure 106. The conductive enclosure 106 acts as a Faraday cage and substantially attenuates electromagnetic radiation, including radio waves, from entering or exiting the conductive enclosure 106. In effect, the conductive enclosure 106 is one type of electromagnetic (EM) shield. In certain applications areas that are located within or behind such EM shields may still need to be sensed to obtain important data associated with the shielded area. In some applications drilling a hole through conductive enclosure 106 in order to pass a direct connection (e.g., a wire or fiber optic cable) between the two sensors 102, 104 is not feasible or practical.

Thus, there is a need for methods, apparatuses, and systems that allow two or more wireless communication devices, such as sensors, to transmit/receive information to one another across/through an EM shield.

### SUMMARY

One feature provides an apparatus for communicating one or more signals across an electromagnetic shield. The apparatus comprises a first communication interface positioned at a first side of an electromagnetic (EM) shield, the first communication interface configured to receive a first signal containing data, the first signal incapable of being transmitted across the EM shield, a first processing circuit positioned at the first side of the EM shield and communicatively coupled to the first communication interface, the first processing circuit configured to generate a control signal based on the first signal, and a first transducer positioned at the first side of the EM shield and communicatively coupled to the first processing circuit, the first transducer configured to receive the control signal, generate a second signal based on the control signal, the second signal containing the data, and transmit the second signal across the EM shield to a second side of the EM shield. According to one aspect of the disclosure, the apparatus further comprises a second signal receiver positioned at the second side of the EM shield and configured to receive the transmitted second signal from the first transducer. According to another aspect, the apparatus further comprises a sensor positioned at the first side of the EM shield and in communication with the first communication interface, the sensor configured to generate the first signal after performing a sensing operation, and provide the first signal to the first communication interface.

According to one aspect, the sensor is in wireless communication with the first communication interface, and the first signal is a radio wave signal. According to another aspect, the sensor is in wired communication with the first communication interface, and the first signal is an electrical or an optical signal. According to yet another aspect, the first signal is comprised of at least one of a radio wave signal, a microwave signal, a visible light signal, and/or an ultraviolet signal.

According to one aspect, the second signal receiver is coupled to a sensor network and the data is provided to the sensor network. According to another aspect, the first transducer is an actuator configured to convert the control signal into vibratory motion to generate the second signal, and the second signal is at least one of a sound wave, a mechanical vibration signal, a surface acoustic wave, and/or an ultrasound wave. According to yet another aspect, the second signal receiver is a vibration detector positioned at the second side of the EM shield and configured to convert the second signal into a first electronic signal having the data, and the apparatus further comprises a second communication interface positioned at the second side of the EM shield and communicatively coupled to the vibration detector, where the second communication interface is configured to receive the first electronic signal, and provide the first electronic signal and/or the data to a sensor network.

According to one aspect, the first transducer is a heater or a cooler configured to raise or lower, respectively, a temperature of the EM shield to generate the second signal, and the second signal is a heat signal associated with the temperature of the EM shield. According to another aspect, the second signal receiver is a thermal detection sensor positioned at the second side of the EM shield and configured to convert the second signal into a first electronic signal having the data, and the apparatus further comprises a second communication interface positioned at the second side of the EM shield and communicatively coupled to the thermal detection sensor, where the second communication interface is configured to receive the first electronic signal, and provide the first electronic signal and/or the data to a sensor network. According to yet another aspect, the apparatus further comprises a second processing circuit positioned at the second side of the EM shield, where the second processing circuit configured to receive sensor instruction data, and a second transducer positioned at the second side of the EM shield and communicatively coupled to the second processing circuit, where the second transducer is configured to generate a third signal based on the sensor instruction data, and transmit the third signal across the EM shield to first side of the EM shield. According to another aspect, the apparatus further comprises a third signal receiver positioned at the first side of the EM shield and configured to receive the third signal from the second transducer and provide a second electronic signal based on the third signal to the first processing circuit, the first processing circuit further configured to provide the sensor instruction data retrieved from the second electronic signal to the first communication interface, and wherein the first communication interface is further configured to transmit a fourth signal that includes the sensor instruction data to a sensor positioned at the first side of the EM shield, the fourth signal incapable of being transmitted across the EM shield.

Another feature provides a method for communicating one or more signals across an electromagnetic shield. The method comprises receiving a first signal containing data at a first communication interface positioned at a first side of an electromagnetic (EM) shield, the first signal incapable of being transmitted across the EM shield, generating a control signal based on the first signal at a first processing circuit positioned at the first side of the EM shield, generating a second signal based on the control signal at a first transducer positioned at the first side of the EM shield, the second signal containing the data, and transmitting the second signal across the EM shield from the first transducer to a second signal receiver positioned at a second side of the EM shield. According to one aspect, the method further comprises performing a sensing operation at a sensor positioned at the first side of the EM shield to generate the first signal containing the data, and providing the first signal to the first communication interface. According to another aspect, the first transducer is an actuator configured to convert the control signal into vibratory motion to generate the second signal, and the second signal is at least one of a sound wave, a mechanical vibration signal, a surface acoustic wave, and/or an ultrasound wave.

According to one aspect, the second signal receiver is a vibration detector, and the method further comprises converting, at the vibration detector, the second signal into a first electronic signal having the data, receiving the first electronic signal at a second communication interface positioned at the second side of the EM shield, and providing the first electronic signal and/or the data to a sensor network. According to another aspect, the first transducer is a heater or a cooler configured to raise or lower, respectively, a temperature of the EM shield to generate the second signal, and the second signal is a heat signal associated with the temperature of the EM shield.

According to one aspect, the method further comprises receiving sensor instruction data at a second processing circuit positioned at the second side of the EM shield, generating a third signal based on the sensor instruction data at a second transducer positioned at the second side of the EM shield, transmitting the third signal across the EM shield from the second transducer to the first side of the EM shield, receiving the third signal from the second transducer at a third signal receiver positioned at the first side of the EM shield, providing a second electronic signal based on the third signal from the third signal receiver to the first processing circuit, retrieving, at the first processing circuit, the sensor instruction data from the electronic signal, providing the sensor instruction data to the first communication interface from the first processing circuit, and transmitting a fourth signal that includes the sensor instruction data from the first communication interface to a sensor positioned at the first side of the EM shield, the fourth signal incapable of being transmitted across the EM shield.

Another feature pertains to a system for communicating one or more signals across an electromagnetic shield. The system comprises a sensor positioned at a first side of an electromagnetic (EM) shield and configured to perform a sensing operation to generate a first signal containing data, the first signal incapable of being transmitted across the EM shield. The system further comprises a first mixed signal (MS) device communicatively coupled to the sensor and positioned at the first side of the EM shield, where the first MS device includes a first communication interface configured to receive the first signal containing the data, a first processing circuit communicatively coupled to the first communication interface and configured to generate a control signal based on the first signal, and a first transducer communicatively coupled to the first processing circuit and configured to receive the control signal, generate a second signal containing the data based on the control signal, and transmit the second signal across the EM shield to a second side of the EM shield. The system further comprises a second mixed signal (MS) device positioned at the second side of the EM shield, where the second MS device includes a second signal receiver configured to receive the second signal from the first transducer and generate a first electronic signal containing the data based on the second signal, a second processing circuit communicatively coupled to the second signal receiver and configured to extract the data from the first electronic signal, and a second communication interface communicatively coupled to the second processing circuit and configured to provide the extracted data and/or the first electronic signal to a sensor network.

According to one aspect, the second processing circuit is further configured to receive sensor instruction data, and the second MS device further includes a second transducer communicatively coupled to the second processing circuit, where the second transducer is configured to generate a third signal based on the sensor instruction data, and transmit the third signal across the EM shield to first side of the EM shield. The first MS device further includes a third signal receiver communicatively coupled to the first processing circuit, where the third signal receiver is configured to receive the third signal from the second transducer, and provide a second electronic signal based on the third signal to the first processing circuit, and wherein the first processing circuit is further configured to provide the sensor instruction data retrieved from the second electronic signal to the first communication interface, the first communication interface further configured to transmit a fourth signal that includes the sensor instruction data to the sensor, the fourth signal incapable of being transmitted across the EM shield.

### BRIEF DESCRIPTION OF THE DRAWINGS

FIG. 1 illustrates a schematic block diagram of a wireless communication system found in the prior art.

FIG. 2 illustrates a schematic block diagram of a communication system configured for wireless signal transmission across an EM shield.

FIG. 3 illustrates a schematic block diagram of a first example of a communication system

FIG. 4 illustrates a schematic block diagram of a second example of a communication system where a transducer is an actuator configured to generate vibratory motion.

FIG. 5 illustrates a schematic block diagram of a third example of a communication system where a transducer is a heater and/or cooler configured to generate heat or remove heat, respectively.

FIG. 6 illustrates a flow chart for a method of communicating (e.g., transmitting and/or receiving) one or more signals across an EM shield.

FIG. 7 illustrates a schematic block diagram of another communication system configured for wireless signal transmission and reception across an EM shield.

FIG. 8 illustrates a schematic block diagram of a communication system featuring a dual transducers and dual signal receivers/detectors.

FIG. 9 illustrates a schematic block diagram of a communication system featuring dual actuators and dual vibration detectors.

FIG. 10 illustrates a schematic block diagram of a communication system featuring dual heaters and/or coolers and dual thermal detection sensors.

FIG. 11 illustrates a flow chart for another method of communicating (e.g., transmitting and/or receiving) one or more signals across an EM shield.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. As used herein, the phrase “communicatively coupled” means that two components are in communication with each other through at least one of a wired connection (e.g., conductive wire or fiber optic cable) and/or wirelessly.

### Overview

Among other things, an apparatus for communicating signals across an electromagnetic (EM) shield is disclosed. The apparatus includes a first communication interface positioned at a first side of the EM shield that receives a first signal containing data, where the first signal is incapable of being transmitted across the EM shield. The apparatus also includes a processing circuit positioned at the EM shield's first side that generates a control signal based on the first signal. The apparatus further includes a transducer positioned at the EM shield's first side that receives the control signal, generates a second signal containing the data based on the control signal, and transmits the second signal across the EM shield to a second side of the EM shield. The apparatus may further include a second signal receiver positioned at the second side of the EM shield that receives the transmitted second signal from the first transducer.

### Exemplary Apparatuses, Systems, and Methods For Signal Transmission Across an EM Shield

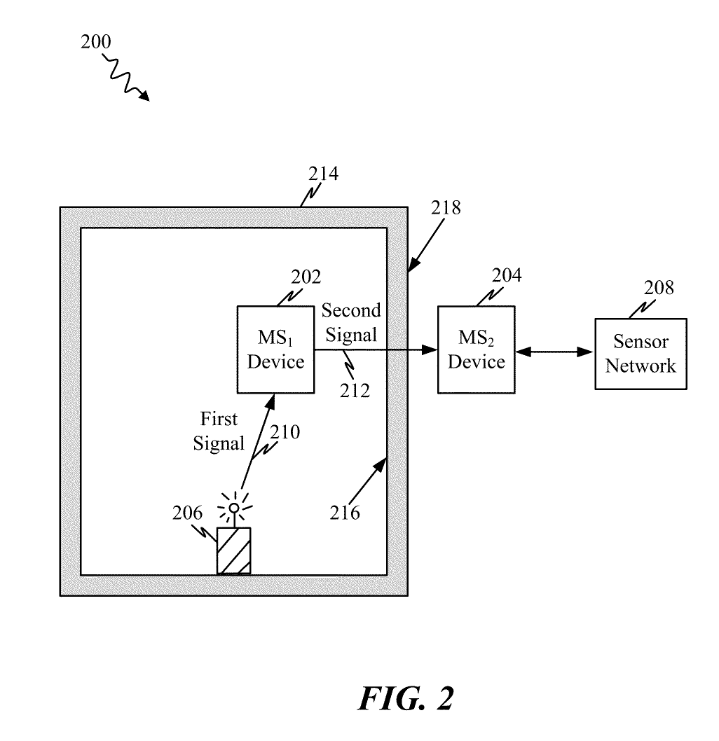

FIG. 2 illustrates a schematic block diagram of a communication system 200 configured for wireless signal transmission across an EM shield according to one aspect of the disclosure. The system 200 may include a first mixed signal (MS) device 202, a second MS device 204, a sensor 206, and/or a sensor network 208. The sensor 206 and the first MS device 202 are positioned at a first side 216 of an EM shield 214 (e.g., enclosed within the EM shield 214), while the second MS device 204 and the sensor network 206 are positioned at a second, opposite side 218 of the EM shield 214 (e.g., outside of the enclosure).

The EM shield 214 may be comprised of a solid metal conductive material on all sides. Generally however, the EM shield 214 does not have to be enclosed on all sides but instead may be any barrier (e.g., conductive barrier) that prevents (or substantially attenuates) EM radiation, such as radio waves, microwaves, and light waves from passing through. For example the EM shield 214 may be a single, large, planar metal sheet that substantially prevents radio waves originating at one side of the metal sheet from reaching the other, opposite side of the metal sheet.

The sensor 206 is configured to perform sensing operations at the first side 216 of the EM shield 214. These sensing operations may include but are not limited to obtaining data related to temperature, pressure, humidity, ionizing radiation levels, luminosity, noise, the presence of toxic and/or flammable gases, system damage, etc. at the first side 216 of the EM shield 214. The sensor 206 may then transmit a first signal 210 having the data obtained to the first MS device 202. The sensor 206 may transmit the first signal 210 in a number of different ways. For example, the sensor 206 may transmit the first signal 210 to the first MS device 202 wirelessly via a radio wave signal, a microwave signal, a visible light wave signal, and/or an ultraviolet wave signal. According to another example, the sensor 206 may be directly coupled to the first MS device 202 so that it transmits the first signal 210 to the first MS device 202 via a conductive wire and/or a fiber optic cable. Notably, the first signal 210 is transmitted by a type of signal that is incapable of being transmitted directly through/across the EM shield 214. For example, if the first signal 210 is a radio wave signal (e.g., near field, short wave, and/or long wave) it cannot pass through/across the EM shield 214 because the EM shield 214 acts as a Faraday cage that blocks such signals. Similarly, if the first signal 210 is a visible light wave signal it cannot pass through/across the EM shield 214 if the EM shield 214 is an opaque, solid Faraday cage (i.e., no holes/mesh).

Upon receiving the first signal 210, the first MS device 202 may process the first signal 210. This processing may include down-conversion, demodulation, and/or other processing steps. After such processing, the first MS device 202 generates a second signal 212 that is based on the first signal 210. For example, the second signal 212 also includes at least a portion if not all of the data associated with the first signal 210. Notably, the second signal 212 is a type of signal that can readily be transmitted directly through the EM shield 214. For example, the second signal 212 may be but is not limited to an acoustic signal, ultrasonic signal, a mechanical vibration signal, a surface acoustic wave (SAW) signal, a thermal signal, etc. Generally the second signal 212 is of a type that can penetrate and/or be carried through the EM shield 214. The first MS device 202 transmits the second signal 212 including the data across the EM shield 214 to the second MS device 204.

Upon receiving the second signal 212, the second MS device 204 may process the second signal 212. This processing may include demodulation and/or other processing steps that may extract the data carried by the second signal 212. After such processing, the second MS device 204 may use the data itself and/or provide the data to the sensor network 208 that includes one or more processors, sensors, computers, memory circuits, and/or networks.

In this fashion, data obtained by the sensor 206 positioned at the first side 216 of the EM shield 214 may be provided to the second MS device 204 and/or the sensor network 208 despite both the second MS device 204 and the sensor network 208 being positioned on the second side 218 of the EM shield 214 (i.e., an EM shield 214 stands between the sensor 206 and the second MS device 204/sensor network 208). The first MS device 202 essentially converts the first signal 210 that cannot be transmitted across the EM shield 214 into a second signal 212 that can be transmitted across the EM shield. Both the first and the second signals 210, 212 may contain the same data obtained by the sensor 206.

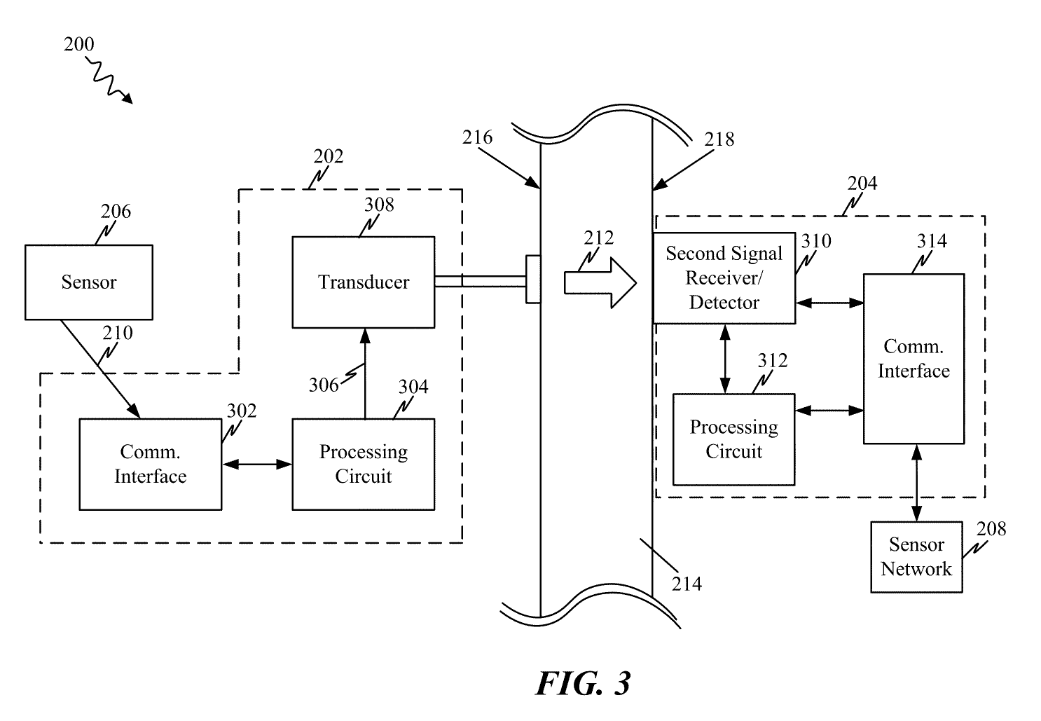

FIG. 3 illustrates a schematic block diagram of the communication system 200 according to one aspect. In the illustrated example, the first MS device 202 comprises a first communication interface 302, a first processing circuit 304, and/or a transducer 308. The first communication interface 302 may be a wireless and/or a wired communication interface. The first processing circuit 304 may include one or more processing circuits (processors), logic, memory circuits, etc. The transducer 308 converts one type of energy (e.g., electromagnetic, electrical, etc.) that cannot readily be transmitted across the EM shield 214 into another type of energy (e.g., acoustic, mechanical, thermal, etc.) that can be transmitted across the EM shield 214.

The second MS device 204 comprises a second signal receiver/detector 310, a second processing circuit 312, and/or a second communication interface 314. The second communication interface 314 may be a wireless and/or a wired communication interface. The second processing circuit 312 may include one or more processing circuits (processors), logic, memory circuits, etc. The second signal receiver/detector 310 is configured to receive/detect the second signal 212.

As described above, the sensor 206 is configured to perform sensing operations at the first side 216 of the EM shield 214. These sensing operations may include but are not limited to obtaining data related to temperature, pressure, humidity, ionizing radiation levels, luminosity, noise, gases, system damage, etc. at the first side 216 of the EM shield 214. The sensor 206 may then transmit the first signal 210 having the data obtained to the first communication interface 302. The sensor 206 may transmit the first signal 210 to the first communication interface 302 wirelessly by including but not limited to a radio wave signal, a microwave signal, a visible light wave signal, and/or an ultraviolet wave signal. According to another example, the sensor 206 may be directly coupled to the first communication interface 302 so that it transmits the first signal 210 to the first communication interface 302 via a conductive wire and/or a fiber optic cable. The first signal 210 is transmitted by a type of signal that is incapable of being transmitted directly through/across the EM shield 214.

After receiving the first signal 210, the first communication interface 302 may down-convert the signal and/or digitize it and provide it to the first processing circuit 304. The first processing circuit 304 may process the first signal 210, including performing demodulation and other processing steps. The first processing circuit 304 may also generate a control signal 306 based on the first signal 210 and provides the control signal 306 to the transducer 308. The transducer 308 receives the control signal 306, and generates the second signal 212 based on the control signal 306 and/or the first signal 210. The transducer 308 then transmits the second signal 212 across the EM shield 214 to the second side 218 of the EM shield 214.

The second signal 212 includes at least a portion if not all of the data associated with the first signal 210. Notably, the second signal 212 is a type of signal that can readily be transmitted directly through the EM shield 214. For example, the second signal 212 may be but is not limited to an acoustic signal, mechanical vibration signal, ultrasonic signal, a surface acoustic wave (SAW) signal, a thermal signal, etc. Generally the second signal 212 is of a type that can penetrate and/or be carried through the EM shield 214.

At the second side 218 of the EM shield 214, the second signal receiver 310 (e.g., second signal detector) receives/detects the second signal 212. The receiver 310 may then provide the second signal 212 and/or a first electronic signal based on the second signal 212 and/or the first electronic signal to the second processing circuit 312 and/or the second communication interface 314. The second processing circuit 312 may extract the data carried by the second signal 212 and/or the first electronic signal and provide it to the second communication interface 314. Alternatively, the second signal receiver 310 may extract the data itself and provide it to the second communication interface 314. The second communication interface 314 may then provide the data to the sensor network 208 that includes one or more processors, sensors, computers, memory circuits, and/or networks. In this fashion, the transducer 308 converts the first signal 210 into a second signal 212 that can permeate the EM shield 214 and transmits the second signal 212 across the EM shield 214 in order to provide the sensor's 206 data to the sensor network 208.

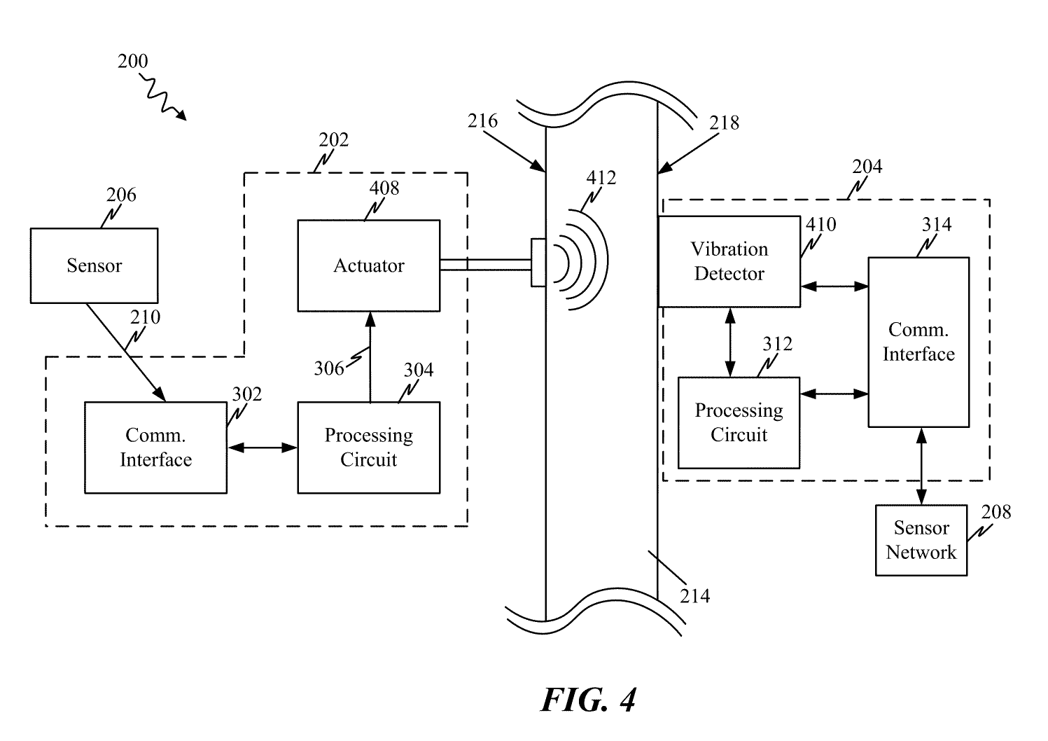

FIG. 4 illustrates a schematic block diagram of the communication system 200 where the transducer is an actuator configured to generate vibratory motion. In the illustrated example, the first MS device 202 comprises the first communication interface 302, the first processing circuit 304, and an actuator 408. The actuator 408 (e.g., piezoelectric transducer) converts electrical energy/signals that cannot be directly transmitted across the EM shield 214 into vibratory energy (e.g., acoustic, SAW, mechanical vibration, and/or ultrasound) that can be transmitted across the EM shield 214. The second MS device 206 comprises a vibration detector 410, the second processing circuit 312, and the second communication interface 314. The vibration detector 410 is configured to receive/detect vibratory energy/signals and generate electrical signals based on the vibratory signals.

According to one example, the actuator 408 may be an acoustic speaker, an ultrasonic generator, and/or a surface acoustic wave (SAW) transducer that generates sound, ultrasonic waves, and/or surface acoustic waves, respectively, based on one or more electrical input control signals (e.g., control signal 306). According to one example the vibration detector 410 is an acoustic microphone, an ultrasonic capacitive microphone, and/or a SAW detector sensor that receives acoustic sound waves, ultrasonic sound waves, and surface acoustic waves, respectively, and generates one or more electrical signal outputs.

Referring to FIG. 4, the sensor 206 is configured to perform sensing operations at the first side 216 of the EM shield 214 to collect data and generate the first signal 210 containing the data. The sensor 206 then transmits the first signal 210 having the data obtained to the first communication interface 302. The first signal 210 is transmitted by a type of signal (e.g., radio wave, visible light wave, etc.) that is incapable of being transmitted directly through/across the EM shield 214. The first communication interface 302 provides the first signal 210 to the first processing circuit 304. The first processing circuit 304 generates the control signal 306 based on the first signal 210 and provides the control signal 306 to the actuator 408. The actuator 408 receives the control signal 306, and generates the vibratory acoustic, ultrasonic, SAW, etc. second signal 412 based on the control signal 306 and/or the first signal 210. The actuator 408 then transmits the second signal 412 across the EM shield 214 to the second side 218 of the EM shield 214. According to one aspect, the actuator 408 and/or a vibratory portion thereof may be coupled directly to the first surface 216 of the EM shield 214 to maximize penetration of the second signal 412 across the EM shield 214 to the second side 218.

At the second side 218 of the EM shield 214, the vibration detector 410 receives/detects the second signal 412. The vibration detector 410 may then provide the second signal 412 and/or a first electronic signal based on the second signal 412 to the second processing circuit 312 and/or the second communication interface 314. The second processing circuit 312 may extract the data carried by the second signal 412 and/or the first electronic signal and provide it to the second communication interface 314. Alternatively, the second signal receiver 310 may extract the data itself and provide it to the second communication interface 314. The second communication interface 314 may then provide the data to the sensor network 208 that includes one or more processors, sensors, computers, memory circuits, and/or networks.

In this fashion, the actuator 408 converts the first signal 210 into a second signal 412 characterized by vibratory motion that can permeate the EM shield 214 in order to provide the sensor's 206 data to the sensor network 208.

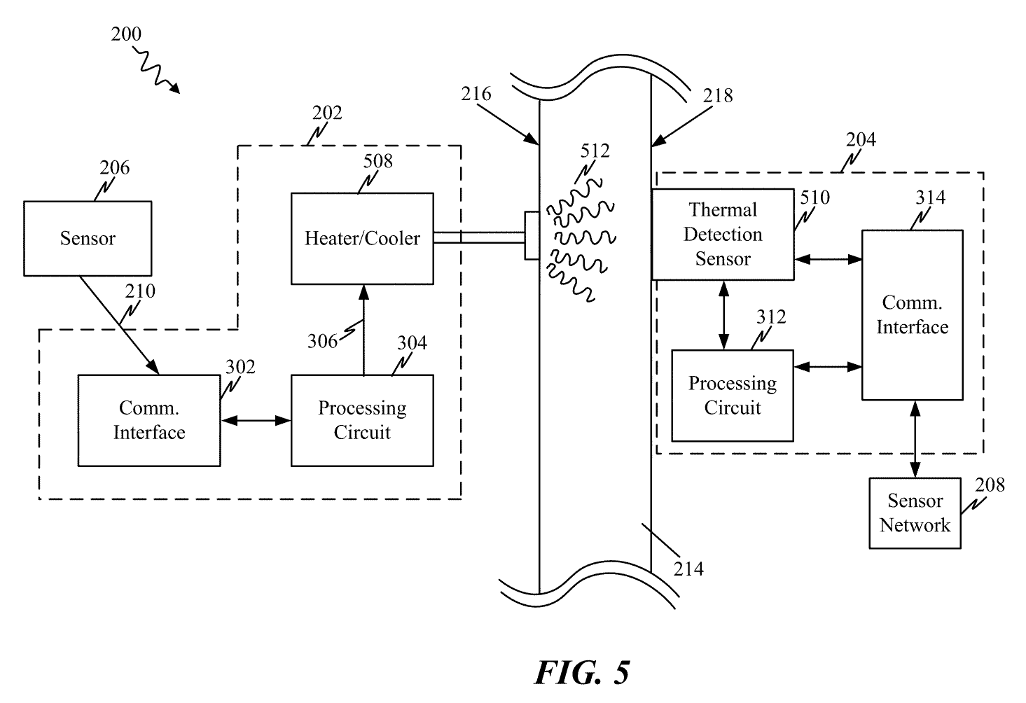

FIG. 5 illustrates a schematic block diagram of the communication system 200 where the transducer is a heater and/or cooler configured to generate heat or remove heat, respectively. In the illustrated example, the first MS device 202 comprises the first communication interface 302, the first processing circuit 304, and a heater and/or cooler 508. The heater and/or cooler 508 converts electrical energy/signals that cannot be directly transmitted across the EM shield 214 into thermal energy that can be transmitted across the EM shield 214 (e.g., the EM shield 214 heats up or cools down). The second MS device 206 comprises a thermal detection sensor 510, the second processing circuit 312, and the second communication interface 314. The thermal detection sensor 510 is configured to detect thermal energy (or a lack thereof) and generate electrical signals based on the thermal energy.

According to one example, the heater and/or cooler 508 may be at least one of: an electric heater that generates heat based on an electrical input control signal (e.g., control signal 306); and/or a thermoelectric cooler (e.g., Peltier cooler) that removes heat based on an electrical input control signal (e.g., control signal 306).

According to one example the thermal detection sensor 510 is any type of detector/sensor that can detect/receive an increase and/or decrease in heat (e.g., temperature) and generate electrical signal outputs based on that change. The thermal detection sensor 510 may be but is not limited to a thermistor, thermocouple, and/or resistance thermometers.

Referring to FIG. 5, the sensor 206 is configured to perform sensing operations at the first side 216 of the EM shield 214 to collect data and generate the first signal 210 containing the data. The sensor 206 then transmits the first signal 210 having the data obtained to the first communication interface 302. The first signal 210 is transmitted by a type of signal (e.g., radio wave, visible light wave, etc.) that is incapable of being transmitted directly through/across the EM shield 214. The first communication interface 302 provides the first signal 210 to the first processing circuit 304. The first processing circuit 304 generates the control signal 306 based on the first signal 210 and provides the control signal 306 to the heater and/or cooler 508. The heater and/or cooler 508 receives the control signal 306, and generates/removes heat from the EM shield 214 thereby transmitting the thermal second signal 512 based on the control signal 306 and/or the first signal 210 to the second side 218 of the EM shield 214. Thus, if the EM shield 214 is heated up on the first side 216 by the heater and/or cooler 508 then that heat may be detected by the thermal detection sensor 510 on the second side 218 of the EM shield 214. Similarly, if the EM shield 214 is cooled down on the first side 216 by the heater and/or cooler 508 then the cooling may be detected by the thermal detection sensor 510 on the second side 218 of the EM shield 214. According to one aspect, the heater and/or cooler 508 may be coupled directly to the first surface 216 of the EM shield 214 to maximize penetration of the thermal second signal 512 across the EM shield 512 to the second side 218.

At the second side 218 of the EM shield 214, the thermal detection sensor 510 receives/detects the second signal 512. The thermal detection sensor 510 may then provide the second signal 512 and/or a first electronic signal based on the second signal 512 to the second processing circuit 312 and/or the second communication interface 314. The second processing circuit 312 may extract the data carried by the second signal 512 and/or the first electronic signal and provide it to the second communication interface 314. Alternatively, the second signal receiver 310 may extract the data itself and provide it to the second communication interface 314. The second communication interface 314 may then provide the data to the sensor network 208 that includes one or more processors, sensors, computers, memory circuits, and/or networks.

In this fashion, the heater and/or cooler 508 converts the first signal 210 into a second signal 512 characterized by vibratory motion that can permeate the EM shield 214 in order to provide the sensor's 206 data to the sensor network 208.

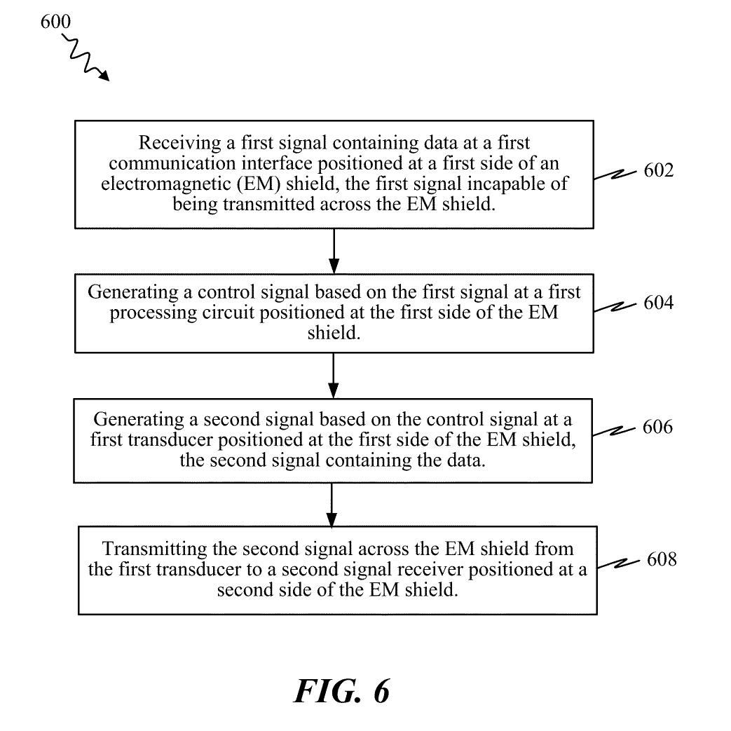

FIG. 6 illustrates a flow chart for a method 600 of transmitting and/or receiving one or more signals across an EM shield. First, a first signal containing data is received at a first communication interface positioned at a first side of an electromagnetic (EM) shield, where the first signal incapable of being transmitted across the EM shield 602. Next, a control signal is generated based on the first signal at a first processing circuit at the first side of the EM shield 604. Then, a second signal based on the control signal is generated at a first transducer positioned at the first side of the EM shield, where the second signal contains the data 606. Next, the second signal is transmitted across the EM shield from the first transducer to a second side of the EM shield 608.

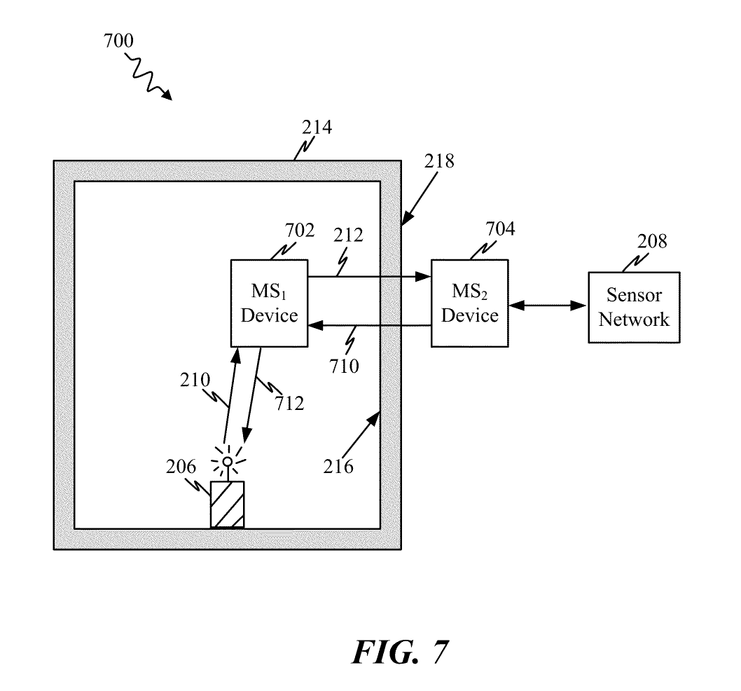

FIG. 7 illustrates a schematic block diagram of a communication system 700 configured for wireless signal transmission and reception across an EM shield according to one aspect of the disclosure. The communication system 700 shown in FIG. 7 is substantially similar to the communication system 200 shown in FIG. 2, except that the second mixed signal (MS) device 704 is configured to also transmit a third signal 710 to the first mixed signal (MS) device 702, and the first MS device 702 is configured to also transmit a fourth signal 712 to the sensor 206.

Like the second signal 212, the third signal 710 can permeate the EM shield 214 and is capable of being transmitted directly through the EM shield 214. The third signal 710 may be but is not limited to a mechanical vibration signal, a sound signal, a SAW signal, a thermal signal, and/or an ultrasonic signal. The third signal 710 may include information/data that provides, for example, instructions and/or control information from the sensor network 208 and/or the second MS device 704 to the sensor 206 and/or the first MS device 702. The fourth signal 712 may be a type of signal that is incapable of being transmitted across the EM shield 214. For example, the fourth signal 712 may be a wireless EM signal (e.g., radio wave, microwave, visible light, etc.) or a wired signal such as an electrical signal or fiber optic cable signal. The fourth signal 712 may include the instructions and/or control information received by the first MS device 702 that provide instructions to the sensor 206.

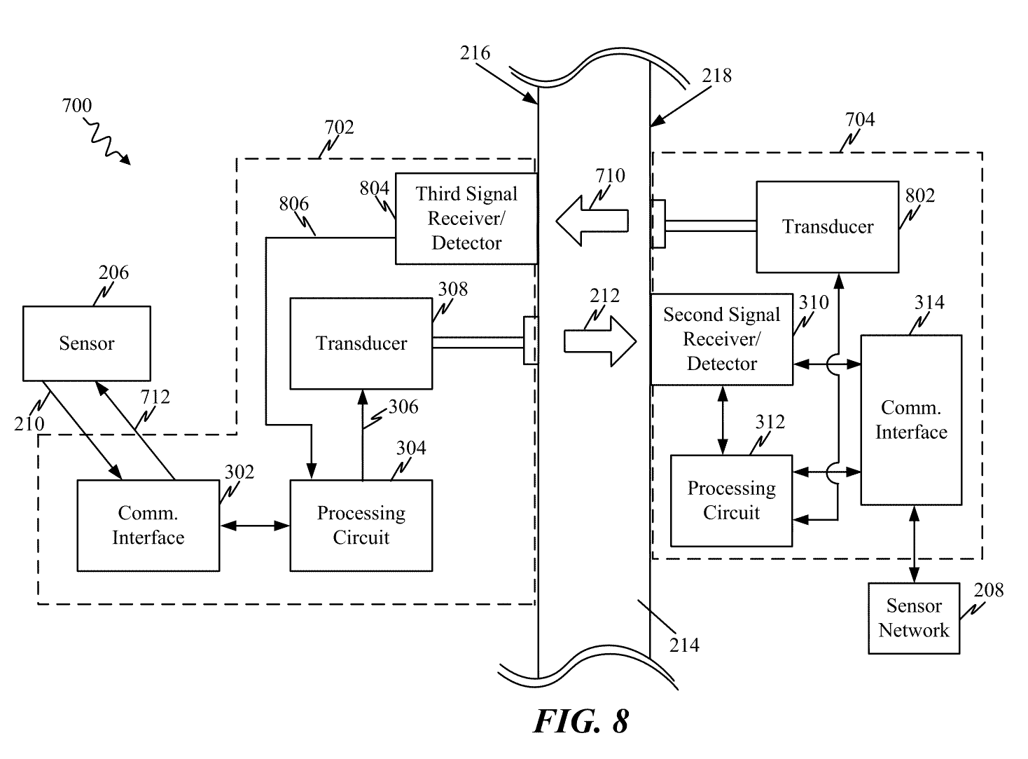

FIG. 8 illustrates a schematic block diagram of the communication system 700 according to one aspect. The communication system 700 shown in FIG. 8 is substantially similar to the communication system 200 shown in FIG. 3, except that the second MS device 704 further comprises a second transducer 802, and the first MS device 702 further comprises a third signal receiver (e.g., third signal detector) 804. The second transducer 802 is configured to transmit the third signal 710 across the EM shield 214 (i.e., from the second side 218 to the first side 216 of the EM shield 214) to the third signal receiver/detector 804.

According to one aspect, the second processing circuit 312 may receive sensor instruction data from the sensor network 208 via the second communication interface 314, and/or generate the sensor instruction data itself (i.e., at the second processing circuit 312). The processing circuit 312 may then provide the sensor instruction data to the second transducer 802. The second transducer 802 generates the third signal 710 based on the sensor instruction data and transmits the third signal 710 across the EM shield 214 to the third signal receiver/detector 804. As described above, the third signal 710 is capable of being transmitted directly through the EM shield 214 because it may be a mechanical vibration signal, a sound signal, a SAW signal, a thermal signal, and/or an ultrasonic signal.

At the first side 216 of the EM shield 214, the third signal receiver 804 receives/detects the third signal 710. The receiver 804 may then provide the third signal 710 and/or a second electronic signal 806 based on the third signal 710 (i.e., second electronic signal 806 includes the sensor instruction data) to the first processing circuit 304. The first processing circuit 304 may then provide the sensor instruction data to the first communication interface 302. The first communication interface 302 may then transmit the fourth signal 712 that includes the sensor instruction data to the sensor 206. As described above, the fourth signal 712 is a type of signal (e.g., EM wave signal) that may be incapable of being transmitted across the EM shield 214. The sensor instruction data may instruct the sensor 206 to perform sensing operations.

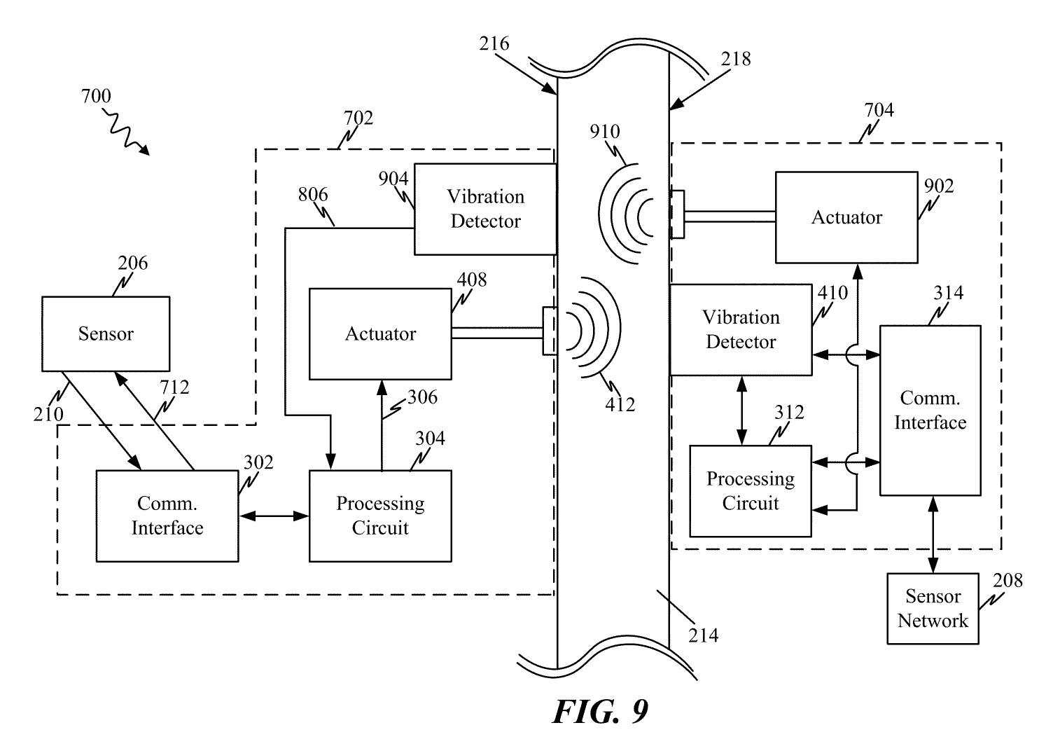

FIG. 9 illustrates a schematic block diagram of the communication system 700 according to another aspect. The communication system 700 shown in FIG. 9 is substantially similar to the communication system 200 shown in FIG. 4, except that the second MS device 704 further comprises a second actuator 902, and the first MS device 702 further comprises a second vibration detector 904. Like the first actuator 408, the second actuator 902 (e.g., piezoelectric transducer) converts electrical energy/signals that cannot be directly transmitted across the EM shield 214 into vibratory energy (e.g., acoustic, SAW, mechanical vibration, and/or ultrasound) that can be transmitted across the EM shield 214. Similar to the first vibration detector 410, the second vibration detector 904 is configured to receive/detect vibratory energy/signals and generate electrical signals based on the vibratory signals.

The second actuator 902 is configured to transmit the third signal 910 across the EM shield 214 (i.e., from the second side 218 to the first side 216 of the EM shield 214) to the second vibration detector 904. The third signal 910 generated by the second actuator 902 may be a mechanical vibration signal, a sound signal, an ultrasound signal, and/or a SAW signal.

At the first side 216 of the EM shield 214, the second vibration detector 904 detects the third signal 910. The vibration detector 904 may then provide the third signal 910 and/or a second electronic signal 806 based on the third signal 910 (i.e., second electronic signal 806 includes the sensor instruction data) to the first processing circuit 304. The first processing circuit 304 may then provide the sensor instruction data to the first communication interface 302. The first communication interface 302 may then transmit the fourth signal 712 that includes the sensor instruction data to the sensor 206. As described above, the fourth signal 712 is a type of signal (e.g., EM wave signal) that may be incapable of being transmitted across the EM shield 214. The sensor instruction data may instruct the sensor 206 to perform sensing operations.

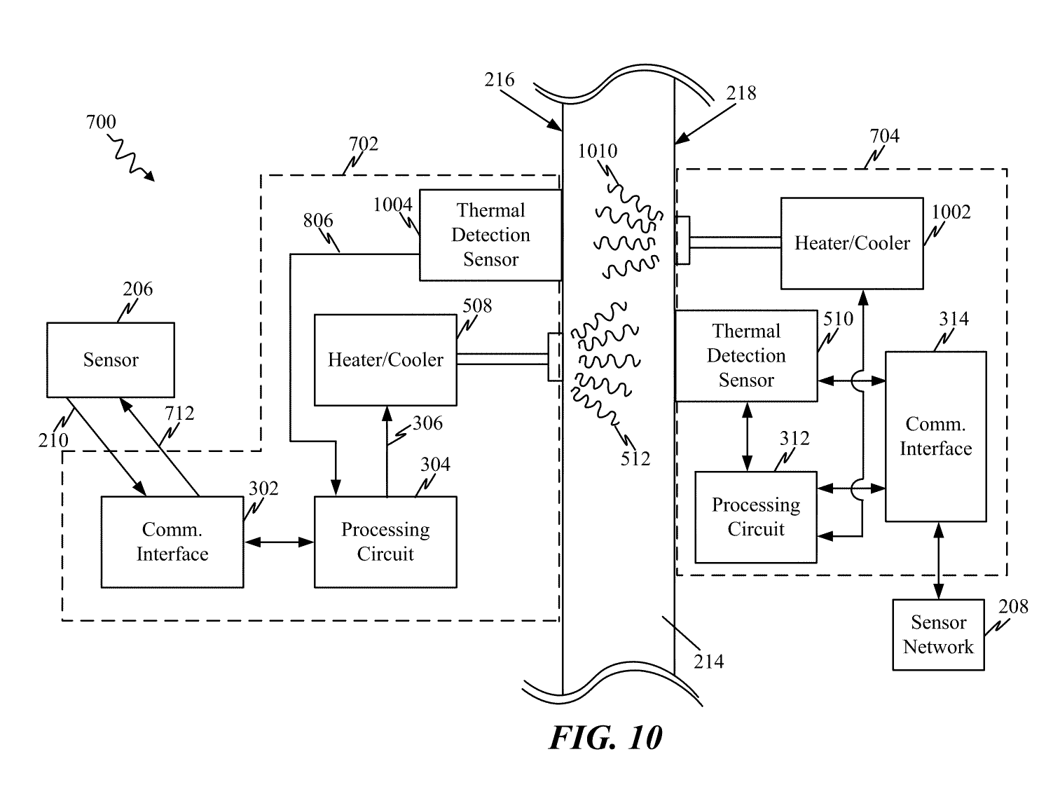

FIG. 10 illustrates a schematic block diagram of the communication system 700 according to another aspect. The communication system 700 shown in FIG. 10 is substantially similar to the communication system 200 shown in FIG. 5, except that the second MS device 704 further comprises a second heater and/or cooler 1002, and the first MS device 702 further comprises a second thermal detection sensor 1004. Like the first heater and/or cooler 508, the second heater and/or cooler 1002 converts electrical energy/signals that cannot be directly transmitted across the EM shield 214 into thermal energy that can be transmitted across the EM shield 214 (e.g., the EM shield 214 heats up or cools down). Similar to the first thermal detection sensor 510, the second thermal detection sensor 1004 is configured to detect thermal energy (or a lack thereof) and generate electrical signals based on the thermal energy.

The second heater and/or cooler 1002 is configured to transmit the third signal 1010 across the EM shield 214 (i.e., from the second side 218 to the first side 216 of the EM shield 214) to the second thermal detection sensor 1004. The third signal 1010 generated by the second thermal detection sensor 1004 is thermal signal such that it transmits heat or removes heat through/from the EM shield 214. Thus, if the EM shield 214 is heated up on the second side 218 by the heater and/or cooler 1002 then that heat may be detected by the second thermal detection sensor 1004 on the first side 216 of the EM shield 214. Similarly, if the EM shield 214 is cooled down on the second side 218 by the heater and/or cooler 1002 then the cooling may be detected by the second thermal detection sensor 1004 on the first side 216 of the EM shield 214.

At the first side 216 of the EM shield 214, the second thermal detection sensor 1004 receives/detects the third signal 1010. The thermal detection sensor 1004 may then provide the third signal 1010 and/or a second electronic signal 806 based on the third signal 1010 (i.e., second electronic signal 806 includes the sensor instruction data) to the first processing circuit 304. The first processing circuit 304 may then provide the sensor instruction data to the first communication interface 302. The first communication interface 302 may then transmit the fourth signal 712 that includes the sensor instruction data to the sensor 206. As described above, the fourth signal 712 is a type of signal (e.g., EM wave signal) that may be incapable of being transmitted across the EM shield 214. The sensor instruction data may instruct the sensor 206 to perform sensing operations.

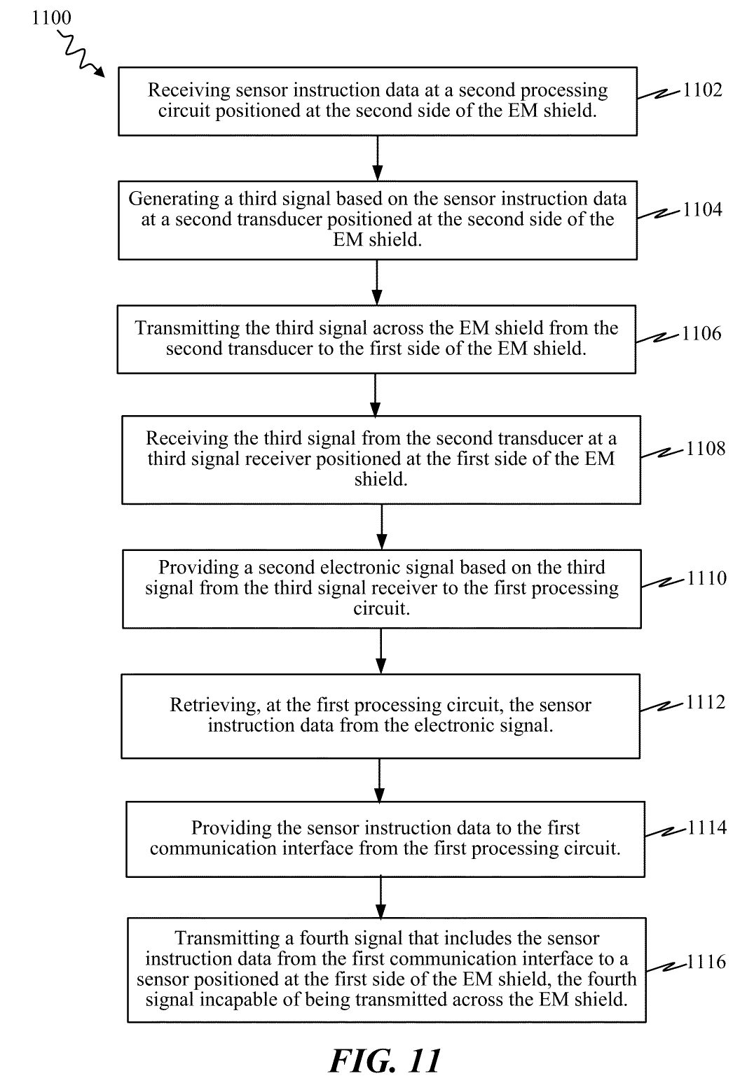

FIG. 11 illustrates a method 1100 for communicating one or more signals across an EM shield according to one aspect. First, a second processing circuit positioned at a second side of an EM shield receives sensor instruction data 1102. Next, a third signal based on the sensor instruction data is generated at a second transducer positioned at the second side of the EM shield 1104. Then, the third signal is transmitted across the EM shield from the second transducer to a first side of the EM shield 1106. Next, the third signal is received from the second transducer at a third signal receiver positioned at the first side of the EM shield 1108. Then, a second electronic signal based on the third signal is provided from the third signal receiver to the first processing circuit 1110. Next, the sensor instruction data is retrieved by the first processing circuit from the electronic signal 1112. Then, the sensor instruction data is provided to the first communication interface from the first processing circuit 1114. Next, a fourth signal that includes the sensor instruction data is transmitted from the first communication interface to a sensor positioned at the first side of the EM shield, where the fourth signal incapable of being transmitted across the EM shield 1116.

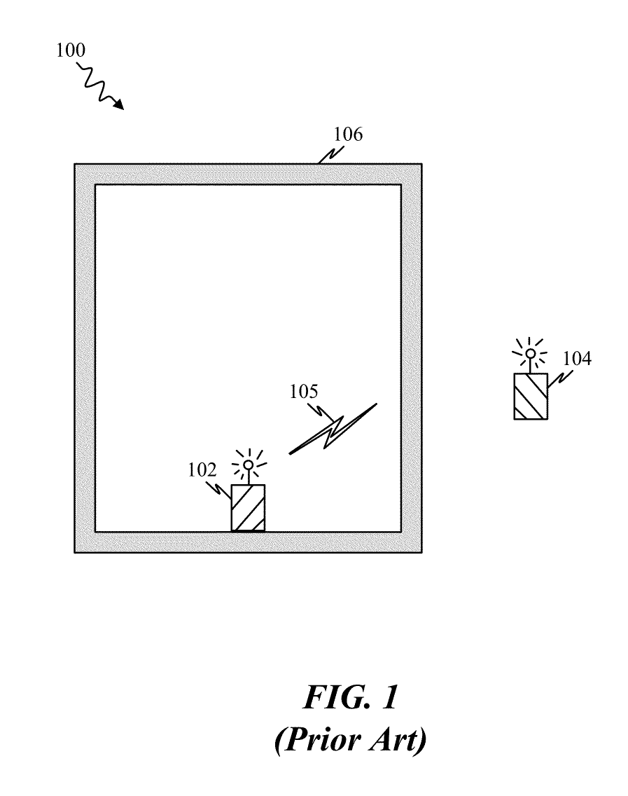

One or more of the components, steps, features, and/or functions illustrated in FIGS. 1, 2, 3, 4, 5, 6, 7, 8, 9, 10, and/or 11 may be rearranged and/or combined into a single component, step, feature or function or embodied in several components, steps, or functions. Additional elements, components, steps, and/or functions may also be added without departing from the invention. The apparatus, devices, and/or components illustrated in FIGS. 2, 3, 4, 5, 7, 8, 9, and/or 10 may be configured to perform one or more of the methods, features, or steps described in FIGS. 6 and 11. The algorithms described herein may also be efficiently implemented in software and/or embedded in hardware.

Also, it is noted that the aspects of the present disclosure may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, aspects of the disclosure may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. An apparatus for communicating one or more signals across an electromagnetic shield, the apparatus comprising:
a first communication interface positioned at a first side of an electromagnetic (EM) shield, the first communication interface configured to receive a first signal containing data, the first signal incapable of being transmitted across the EM shield;
a first processing circuit positioned at the first side of the EM shield and communicatively coupled to the first communication interface, the first processing circuit configured to generate a control signal based on the first signal; and
a first transducer positioned at the first side of the EM shield and communicatively coupled to the first processing circuit, the first transducer configured to
receive the control signal,
generate a second signal based on the control signal, the second signal containing the data, and
transmit the second signal across the EM shield to a second side of the EM shield.

2. The apparatus of claim 1, further comprising:
a second signal receiver positioned at the second side of the EM shield and configured to receive the transmitted second signal from the first transducer.

3. The apparatus of claim 1, further comprising:
a sensor positioned at the first side of the EM shield and in communication with the first communication interface, the sensor configured to
generate the first signal after performing a sensing operation, and
provide the first signal to the first communication interface.

4. The apparatus of claim 3, wherein the sensor is in wireless communication with the first communication interface, and the first signal is a radio wave signal.

5. The apparatus of claim 3, wherein the sensor is in wired communication with the first communication interface, and the first signal is an electrical or an optical signal.

6. The apparatus of claim 1, wherein the first signal is comprised of at least one of a radio wave signal, a microwave signal, a visible light signal, and/or an ultraviolet signal.

7. The apparatus of claim 2, wherein the second signal receiver is coupled to a sensor network and the data is provided to the sensor network.

8. The apparatus of claim 2, wherein the first transducer is an actuator configured to convert the control signal into vibratory motion to generate the second signal, and the second signal is at least one of a sound wave, a mechanical vibration signal, a surface acoustic wave, and/or an ultrasound wave.

9. The apparatus of claim 8, wherein the second signal receiver is a vibration detector positioned at the second side of the EM shield and configured to convert the second signal into a first electronic signal having the data, and the apparatus further comprises:
a second communication interface positioned at the second side of the EM shield and communicatively coupled to the vibration detector, the second communication interface configured to
receive the first electronic signal, and
provide the first electronic signal and/or the data to a sensor network.

10. The apparatus of claim 2, wherein the first transducer is a heater or a cooler configured to raise or lower, respectively, a temperature of the EM shield to generate the second signal, and the second signal is a heat signal associated with the temperature of the EM shield.

11. The apparatus of claim 10, wherein the second signal receiver is a thermal detection sensor positioned at the second side of the EM shield and configured to convert the second signal into a first electronic signal having the data, and the apparatus further comprises:
a second communication interface positioned at the second side of the EM shield and communicatively coupled to the thermal detection sensor, the second communication interface configured to
receive the first electronic signal, and
provide the first electronic signal and/or the data to a sensor network.

12. The apparatus of claim 1, further comprising:
a second processing circuit positioned at the second side of the EM shield, the second processing circuit configured to receive sensor instruction data; and
a second transducer positioned at the second side of the EM shield and communicatively coupled to the second processing circuit, the second transducer configured to
generate a third signal based on the sensor instruction data, and
transmit the third signal across the EM shield to the first side of the EM shield.

13. The apparatus of claim 12, further comprising:
a third signal receiver positioned at the first side of the EM shield and configured to receive the third signal from the second transducer and provide a second electronic signal based on the third signal to the first processing circuit, the first processing circuit further configured to provide the sensor instruction data retrieved from the second electronic signal to the first communication interface, and wherein the first communication interface is further configured to transmit a fourth signal that includes the sensor instruction data to a sensor positioned at the first side of the EM shield, the fourth signal incapable of being transmitted across the EM shield.

14. A method for communicating one or more signals across an electromagnetic shield, the method comprising:
receiving a first signal containing data at a first communication interface positioned at a first side of an electromagnetic (EM) shield, the first signal incapable of being transmitted across the EM shield;
generating a control signal based on the first signal at a first processing circuit positioned at the first side of the EM shield;
generating a second signal based on the control signal at a first transducer positioned at the first side of the EM shield, the second signal containing the data; and
transmitting the second signal across the EM shield from the first transducer to a second signal receiver positioned at a second side of the EM shield.

15. The method of claim 14, further comprising:
performing a sensing operation at a sensor positioned at the first side of the EM shield to generate the first signal containing the data; and
providing the first signal to the first communication interface.

16. The method of claim 14, wherein the first transducer is an actuator configured to convert the control signal into vibratory motion to generate the second signal, and the second signal is at least one of a sound wave, a mechanical vibration signal, a surface acoustic wave, and/or an ultrasound wave.

17. The method of claim 16, wherein the second signal receiver is a vibration detector, and the method further comprises:
converting, at the vibration detector, the second signal into a first electronic signal having the data;
receiving the first electronic signal at a second communication interface positioned at the second side of the EM shield; and
providing the first electronic signal and/or the data to a sensor network.

18. The method of claim 14, wherein the first transducer is a heater or a cooler configured to raise or lower, respectively, a temperature of the EM shield to generate the second signal, and the second signal is a heat signal associated with the temperature of the EM shield.

19. The method of claim 14, further comprising:
receiving sensor instruction data at a second processing circuit positioned at the second side of the EM shield;
generating a third signal based on the sensor instruction data at a second transducer positioned at the second side of the EM shield;
transmitting the third signal across the EM shield from the second transducer to the first side of the EM shield;
receiving the third signal from the second transducer at a third signal receiver positioned at the first side of the EM shield;
providing a second electronic signal based on the third signal from the third signal receiver to the first processing circuit;
retrieving, at the first processing circuit, the sensor instruction data from the electronic signal;
providing the sensor instruction data to the first communication interface from the first processing circuit; and
transmitting a fourth signal that includes the sensor instruction data from the first communication interface to a sensor positioned at the first side of the EM shield, the fourth signal incapable of being transmitted across the EM shield.

20. A system for communicating one or more signals across an electromagnetic shield, the system comprising:
a sensor positioned at a first side of an electromagnetic (EM) shield and configured to perform a sensing operation to generate a first signal containing data, the first signal incapable of being transmitted across the EM shield;
a first mixed signal (MS) device communicatively coupled to the sensor and positioned at the first side of the EM shield, the first MS device including
a first communication interface configured to receive the first signal containing the data,
a first processing circuit communicatively coupled to the first communication interface and configured to generate a control signal based on the first signal, and
a first transducer communicatively coupled to the first processing circuit and configured to receive the control signal, generate a second signal containing the data based on the control signal, and transmit the second signal across the EM shield to a second side of the EM shield; and
a second mixed signal (MS) device positioned at the second side of the EM shield, the second MS device including
a second signal receiver configured to receive the second signal from the first transducer and generate a first electronic signal containing the data based on the second signal,
a second processing circuit communicatively coupled to the second signal receiver and configured to extract the data from the first electronic signal, and
a second communication interface communicatively coupled to the second processing circuit and configured to provide the extracted data and/or the first electronic signal to a sensor network.

21. The system of claim 20, wherein the second processing circuit is further configured to receive sensor instruction data, and the second MS device further includes a second transducer communicatively coupled to the second processing circuit, the second transducer configured to
generate a third signal based on the sensor instruction data, and
transmit the third signal across the EM shield to first side of the EM shield, and
wherein the first MS device further includes a third signal receiver communicatively coupled to the first processing circuit, the third signal receiver configured to
receive the third signal from the second transducer, and
provide a second electronic signal based on the third signal to the first processing circuit, and
wherein the first processing circuit is further configured to provide the sensor instruction data retrieved from the second electronic signal to the first communication interface, the first communication interface further configured to transmit a fourth signal that includes the sensor instruction data to the sensor, the fourth signal incapable of being transmitted across the EM shield.
